(19) United States
(12) Patent Application Publication
(10) Pub. No.: US 2026/0003493 A1
(43) Pub. Date: Jan. 1, 2026

(54) INTERACTION METHOD, AUTOSTEREOSCOPIC DEVICE, AND STORAGE MEDIUM

(71) Applicant: Lenovo (Beijing) Limited, Beijing (CN)

(72) Inventor: Cen YAO, Beijing (CN)

(21) Appl. No.: 19/245,218

(22) Filed: Jun. 20, 2025

(30) Foreign Application Priority Data
Jun. 27, 2024 (CN) 202410851285.3

(51) Int. Cl. G06F 3/0488; G06F 3/01; G06F 3/0346; G06F 3/04815; G06F 3/0484

(52) U.S. Cl. CPC G06F 3/0488; G06F 3/013; G06F 3/0346; G06F 3/04815; G06F 3/0484; G06F 2203/04806

(57) ABSTRACT

An interaction method, applied to an autostereoscopic device, includes acquiring first indication information sent by an accessory device interacting with the autostereoscopic device. The first indication information includes at least one of following information: left-right movement information in a horizontal direction, up-down movement information in a vertical direction, or forward-backward movement information in a depth direction. The method also includes, based on the first indication information, adjusting a display position of a target application in a three-dimensional display mode of the autostereoscopic device.

### CROSS-REFERENCES TO RELATED APPLICATIONS

The present disclosure claims priority of Chinese Patent Application No. 202410851285.3, filed on Jun. 27, 2024, the entire content of which is hereby incorporated by reference.

### FIELD OF THE DISCLOSURE

The present disclosure generally relates to the field of electronic technology and, more particularly, relates to an interaction method, an autostereoscopic device, and an accessory device.

### BACKGROUND

In existing technology, an interactive operation on a two-dimensional display interface may be realized. With the development of three-dimensional (3D) display technology, glasses-free 3D display has gradually become one of the mainstream display modes. How to provide adaptive operation functions for interactive operations of interactive objects in a 3D display interface has become a technical problem that needs to be solved urgently.

### SUMMARY

One aspect of the present disclosure includes an interaction method applied to an autostereoscopic device. The method includes acquiring first indication information sent by an accessory device interacting with the autostereoscopic device. The first indication information includes at least one of following information: left-right movement information in a horizontal direction, up-down movement information in a vertical direction, and forward-backward movement information in a depth direction. The method also includes, based on the first indication information, adjusting a display position of a target application in a three-dimensional display mode of the autostereoscopic device.

Another aspect of the present disclosure includes an autostereoscopic device. The autostereoscopic device includes a memory, one or more processors, and an autostereoscopic display screen. The autostereoscopic display screen is configured to display a target application in a three-dimensional display mode. The memory is configured to store a computer program that, when being executed, causes the one or more processors to perform: acquiring first indication information sent by an accessory device interacting with the autostereoscopic device, wherein the first indication information includes at least one of following information: left-right movement information in a horizontal direction, up-down movement information in a vertical direction, or forward-backward movement information in a depth direction; and based on the first indication information, adjusting a display position of the target application in the three-dimensional display mode of the autostereoscopic device.

Another aspect of the present disclosure includes a non-transitory computer readable storage medium containing a computer program that, when being executed, causes at least one processor to perform: acquiring first indication information sent by an accessory device interacting with an autostereoscopic device, wherein the first indication information includes at least one of following information: left-right movement information in a horizontal direction, up-down movement information in a vertical direction, or forward-backward movement information in a depth direction; and based on the first indication information, adjusting a display position of the target application in the three-dimensional display mode of the autostereoscopic device.

Other aspects of the present disclosure may be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1A illustrates an implementation flow chart of an interaction method consistent with the disclosed embodiments of the present disclosure;

FIG. 1B illustrates a schematic diagram of a display interface of an autostereoscopic (3D) device consistent with the disclosed embodiments of the present disclosure;

FIG. 1C illustrates a schematic movement diagram of a smart ring consistent with the disclosed embodiments of the present disclosure;

FIG. 1D illustrates another schematic diagram of a display interface of an autostereoscopic device consistent with the disclosed embodiments of the present disclosure;

FIG. 1E illustrates another schematic movement diagram of a smart ring consistent with the disclosed embodiments of the present disclosure;

FIG. 1F illustrates another schematic diagram of a display interface of an autostereoscopic device consistent with the disclosed embodiments of the present disclosure;

FIG. 1G illustrates another schematic movement diagram of a smart ring consistent with the disclosed embodiments of the present disclosure;

FIG. 1H illustrates another schematic diagram of a display interface of an autostereoscopic device consistent with the disclosed embodiments of the present disclosure;

FIG. 2A illustrates a schematic diagram for determining a target application by eye movement, consistent with the disclosed embodiments of the present disclosure;

FIG. 2B illustrates a schematic interface diagram for determining a target application, consistent with the disclosed embodiments of the present disclosure;

FIG. 2C illustrates a schematic diagram of a pinch gesture consistent with the disclosed embodiments of the present disclosure;

FIG. 2D illustrates a schematic operation diagram for generating a target instruction, consistent with the disclosed embodiments of the present disclosure;

FIG. 3A illustrates an implementation flow chart of another interaction method consistent with the disclosed embodiments of the present disclosure;

FIG. 3B illustrates a schematic diagram of a gesture for bringing a target application closer, consistent with the disclosed embodiments of the present disclosure;

FIG. 3C illustrates a schematic diagram for displaying a target application on an autostereoscopic device consistent with the disclosed embodiments of the present disclosure;

FIG. 3D illustrates a schematic diagram of a gesture for restoring a target application consistent with the disclosed embodiments of the present disclosure;

FIG. 4A illustrates an implementation flow chart for operating a target model, consistent with the disclosed embodiments of the present disclosure;

FIG. 4B illustrates a schematic diagram of a second preset gesture consistent with the disclosed embodiments of the present disclosure;

FIG. 4C illustrates a schematic diagram of a three-dimensional display of a dinosaur model, consistent with the disclosed embodiments of the present disclosure;

FIG. 4D illustrates a schematic diagram of an interaction with a target model consistent with the disclosed embodiments of the present disclosure;

FIG. 4E illustrates a schematic diagram of another interaction with a target model consistent with the disclosed embodiments of the present disclosure;

FIG. 4F illustrates a schematic diagram of another interaction with a target model consistent with the disclosed embodiments of the present disclosure;

FIG. 4G illustrates a schematic diagram of a user touching a return key, consistent with the disclosed embodiments of the present disclosure;

FIG. 5 illustrates an implementation flow chart of another interaction method consistent with the disclosed embodiments of the present disclosure;

FIG. 6A illustrates a schematic diagram of a composition structure of an interactive device consistent with the disclosed embodiments of the present disclosure;

FIG. 6B illustrates a schematic diagram of a composition structure of another interactive device consistent with the disclosed embodiments of the present disclosure; and

FIG. 7 illustrates a schematic diagram of a hardware entity of an electronic device consistent with the disclosed embodiments of the present disclosure.

### DETAILED DESCRIPTION

To make the objectives, technical solutions and advantages of the present disclosure more clear and explicit, the present disclosure is described in further detail with accompanying drawings and embodiments. It should be understood that the specific exemplary embodiments described herein are only for explaining the present disclosure and are not intended to limit the present disclosure.

It should be noted that in the present disclosure, relational terms such as “first” and “second” are only configured to distinguish one entity or operation from another entity or operation, and do not necessarily require or imply that such actual relationship or sequence exists between these entities or operations. Terms “comprise”, “include” or any other variations thereof are intended to cover a non-exclusive inclusion. A process, method, article, or apparatus that includes a series of elements includes not only the series of elements, but also other elements not expressly listed, or elements inherent to such a process, method, article, or apparatus. Without further limitation, an element defined by a statement like “comprises a . . . ” does not exclude the presence of additional identical elements in a process, method, article, or apparatus that includes the foregoing element.

It should be noted that relative arrangements of components and operations, numerical expressions and numerical values set forth in exemplary embodiments are for illustration purposes only and are not intended to limit the present disclosure unless otherwise specified. Techniques, methods and apparatus known to the skilled in the relevant art may not be discussed in detail, but these techniques, methods and apparatus should be considered as a part of the specification, where appropriate.

The present disclosure provides an interaction method applicable to an autostereoscopic device. An autostereoscopic device may also be called glasses-free (or naked-eye) three-dimensional (3D) device. As used herein, the term autostereoscopy is a general term for technologies that achieve stereoscopic visual effects without the help of external tools such as polarized glasses. An autostereoscopic device may include a glasses-free 3D display (or a naked-eye 3D display), which may utilize the parallax characteristics of the human eyes to provide 3D images with space and depth, without the need for accessory vision devices (such as 3D glasses, helmets, etc.).

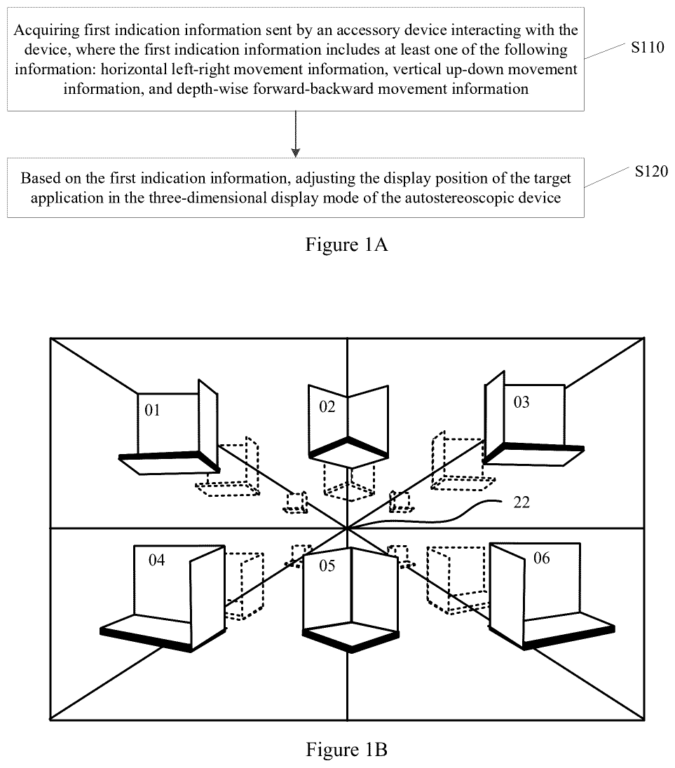

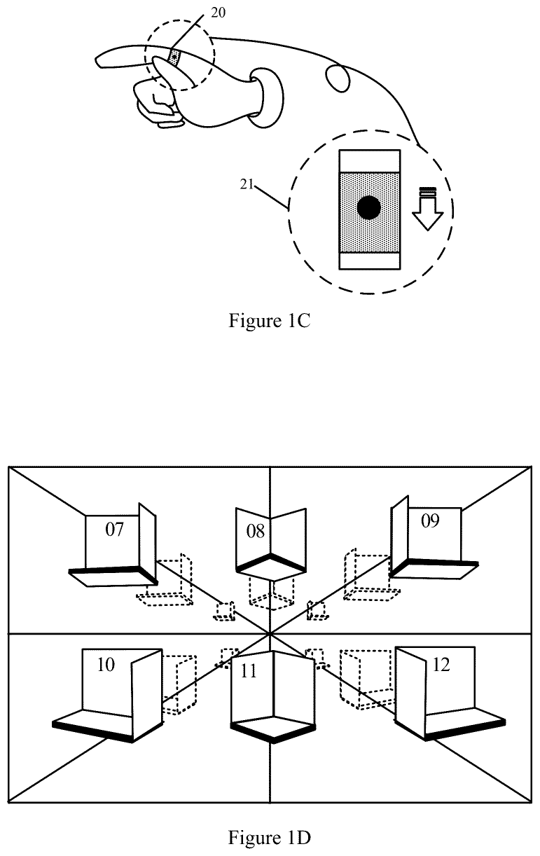

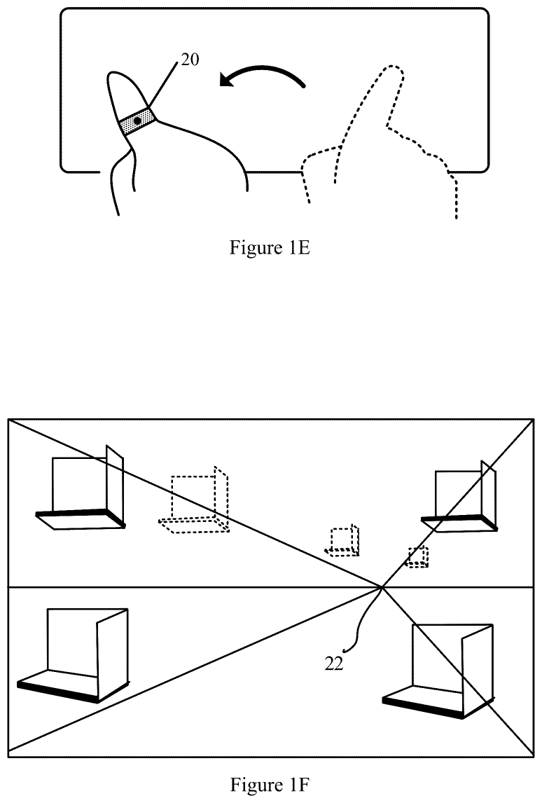

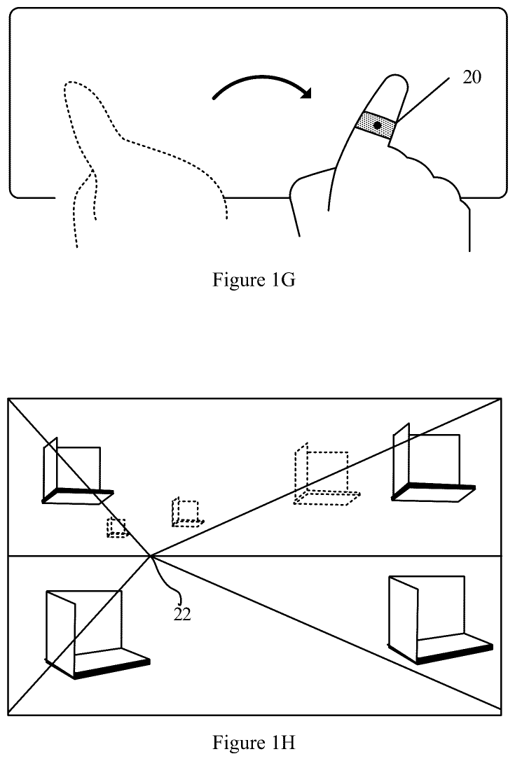

FIG. 1A illustrates an implementation flow chart of an interaction method consistent with the disclosed embodiments of the present disclosure. As shown in FIG. 1A, in one embodiment, the interaction method may include S110 and S120.

S110: acquiring first indication information sent by an accessory device interacting with the autostereoscopic device. The first indication information includes at least one of the following information: horizontal left-right movement information, vertical up-down movement information, and/or depth-wise forward-backward movement information.

The accessory device may be an electronic device that interacts with the autostereoscopic device. For example, the electronic device may be a smart ring, a smart bracelet, an electronic pen, or any other accessory device.

During an implementation process, the accessory device may be operated by a user to move left-right in the horizontal X direction, up-down in the vertical Y direction, and forward-backward in the depth Z direction; and may send the first indication information generated based on the movement information to the autostereoscopic device.

S120: based on the first indication information, adjusting the display position of the target application in the three-dimensional display mode of the autostereoscopic device. In the 3D display mode, the autostereoscopic device may present the target application of 3D stereoscopic display. During an implementation process, the display positions of one or more target applications may be adjusted based on the first indication information sent by the accessory device.

FIG. 1B illustrates a schematic diagram of a display interface of an autostereoscopic device consistent with the disclosed embodiments of the present disclosure. As shown in FIG. 1B, the display interface includes application 01, application 02, application 03, application 04, application 05, application 06 and vanishing point 22 located in the front row of vision. During an implementation process, the positions of the six target applications in the front row and the applications in the back row may be adjusted based on the first indication information. Alternatively, one target application may be selected from the six applications in the front row, and the display position of the target application selected may be adjusted.

For example, a user may manipulate an accessory device such as a smart ring to move in the Z direction. After the autostereoscopic device obtains the movement information in the Z direction, the target application may be accordingly adjusted to move in the Z direction of the display interface.

In one embodiment, first indication information sent by the accessory device interacting with the autostereoscopic device may be obtained first. Then, based on the first indication information, the display position of the target application may be adjusted in the three-dimensional display mode of the autostereoscopic device. In this way, by operating the accessory device, the user may interact with the autostereoscopic device and accordingly adjust the display position of the target application in the 3D mode.

In some embodiments, an operation of S120 “based on the first indication information, adjusting the display position of the target application in the three-dimensional display mode of the autostereoscopic device” may be implemented by S121 and S122.

S121: based on the first indication information, determining that the accessory device moves in at least one of the following directions: vertical up-down direction, horizontal left-right direction, or depth-wise forward-backward direction.

In one embodiment, the accessory device may be a handheld electronic device of the user, such as a smart ring, a bracelet or an electronic pen. The first indication information may be movement information collected by the accessory device, that is, movement information of the electronic device held by the user in the X, Y or Z axis direction. For example, the user may wear a smart ring and move the smart ring left-right along the X-axis, up-down along the Y-axis, or forward-backward along the Z-axis. The smart ring may use at least one of the following sensors: an inertial measurement unit (IMU), a displacement sensor, and/or an angle displacement sensor to determine the movement information of the smart ring and send the movement information to the autostereoscopic device.

During an implementation process, the autostereoscopic device may determine the movement information of the accessory device based on the first indication information obtained, that is, determine whether the accessory device moves in at least one of the following directions: vertical up-down direction, horizontal left-right direction, or depth-wise forward-backward direction.

S122: performing at least one of the following adjustments in the 3D display mode: adjusting the vertical position of at least one of the target applications, adjusting the display viewing angle of at least one of the target applications, or adjusting the front and back positions of at least one of the target applications in the depth direction.

In some embodiments, when it is determined that the accessory device moves up-down in the vertical direction, the up-down position of at least one of the target applications in the vertical direction may be adjusted, the display viewing angle of at least one of the target applications may be adjusted, or the front-back position of at least one of the target applications in the depth direction may be adjusted.

In some embodiments, when it is determined that the accessory device moves horizontally left-right, the up-down position of at least one of the target applications in the vertical direction may be adjusted, the display viewing angle of at least one of the target applications may be adjusted, or the front-back position of at least one of the target applications in the depth direction may be adjusted.

In some embodiments, when it is determined that the accessory device moves forward-backward in the depth direction, the up-down position of at least one of the target applications in the vertical direction may be adjusted, the display viewing angle of at least one of the target applications may be adjusted, or the front-back position of at least one of the target applications in the depth direction may be adjusted.

During the implementation process, the user may set the moving direction of the accessory device and the moving direction of the corresponding target application according to his or her own usage habits.

FIG. 1C illustrates a schematic movement diagram of a smart ring consistent with the disclosed embodiments of the present disclosure. FIG. 1C includes a smart ring 20 and an enlarged moving sub-diagram 21 of the smart ring 20. FIG. 1D illustrates another schematic diagram of a display interface of an autostereoscopic device consistent with the disclosed embodiments of the present disclosure. FIG. 1D includes applications 07, 08, 09, 10, 11 and 12 with the rear row moved forward. When the user moves the smart ring 20 downward as shown in the enlarged moving sub-picture 21 of FIG. 1C, the back row of applications 07, 08, 09, 10, 11 and 12 displayed in the autostereoscopic device may move forward as shown in FIG. 1D.

FIG. 1E illustrates another schematic movement diagram of a smart ring consistent with the disclosed embodiments of the present disclosure. FIG. 1E includes a smart ring 20 worn by a user. FIG. 1F illustrates another schematic diagram of a display interface of an autostereoscopic device consistent with the disclosed embodiments of the present disclosure. FIG. 1F includes a vanishing point 22. When the user slides the smart ring 20 to the left on the desktop as shown in FIG. 1E, the corresponding vanishing point 22 shown in the autostereoscopic device as shown in FIG. 1F may be shifted to the right compared to the vanishing point 22 shown in FIG. 1B, that is, the application may display a right view.

FIG. 1G illustrates another schematic movement diagram of a smart ring consistent with the disclosed embodiments of the present disclosure. FIG. 1G includes a smart ring 20 worn by a user. FIG. 1H illustrates another schematic diagram of a display interface of an autostereoscopic device consistent with the disclosed embodiments of the present disclosure. FIG. 1H includes a vanishing point 22. When the user slides the smart ring 20 to the right on the desktop as shown in FIG. 1G, the corresponding vanishing point 22 shown in the autostereoscopic device may move to the left as shown in FIG. 1H, that is, the application displays a left view.

In one embodiment, based on the first indication information, the accessory device may be determined to move in at least one of the following directions: up-down in the vertical direction, left-right in the horizontal direction, or forward-backward in the depth direction. At least one of the following adjustments in the three-dimensional display mode may be performed: adjusting the vertical position of at least one of the target applications, adjusting the display viewing angle of at least one of the target applications, or adjusting the front-back position of at least one of the target applications in the depth direction. In this way, the user may set the moving direction of the accessory device and the moving direction of the corresponding target application according to his/her own usage habits. Accordingly, the movement of the accessory device may correspond to the position adjustment of the corresponding target application.

In some embodiments, the interaction method may also include S130, S140 and S150.

S130: determining that the accessory device is triggered to rotate, or a user touches and slides on a surface of the accessory device.

The rotation of the accessory device may be that the user rotates the accessory device with the center line of the accessory device as the rotation axis. For example, the user may rotate a smart ring on his/her finger. The user touching and sliding on the surface of the accessory device may be an operation by the user touching and sliding on a sensing area of the smart ring. During an implementation process, the accessory device may send data information corresponding to the above operation to the autostereoscopic device, such that the autostereoscopic device may determine the operation behavior corresponding to the accessory device based on the data information.

S140: performing at least one of the following adjustments in the 3D display mode: adjusting the vertical position of at least one of the target applications, adjusting the display viewing angle of at least one of the target applications, or adjusting the front and back position of at least one of the target applications in the depth direction.

For example, a user may rotate a smart ring worn on a finger to perform at least one of the following adjustments: adjusting the vertical position of at least one of the target applications, adjusting the display viewing angle of at least one of the target applications, or adjusting the front and back position of at least one of the target applications in the depth direction.

A user may touch and slide on the surface of the accessory device to perform at least one of the following adjustments: adjusting the vertical position of at least one of the target applications, adjusting the display viewing angle of at least one of the target applications, or adjusting the front and back position of at least one of the target applications in the depth direction.

During an implementation process, according to his/her own usage habit, a user may set the device rotation of the accessory device or the user contacting and sliding on the surface of the accessory device, and a corresponding movement direction of the target application.

In one embodiment, it may be determined first that the accessory device is triggered to rotate, or a user touches and slides on the surface of the accessory device. Then, at least one of the following adjustments in the 3D display mode may be performed: adjusting the vertical position of at least one of the target applications, adjusting the display viewing angle of at least one of the target applications, or adjusting the front and back position of at least one of the target applications in the depth direction. In this way, since the operation information of the accessory device rotation and the user contacting and sliding on the surface of the accessory device is added, the interaction method between the accessory device and the three-dimensional naked-eye device may be enriched.

In some embodiments, the interaction method may also include at least one of S150, S160, and S170.

S150: determining an application that matches a gaze point of the user as a target application. During an implementation process, a camera device disposed on the autostereoscopic device may be used to determine the gaze point of the user, and the application at the gaze point may be determined as the target application.

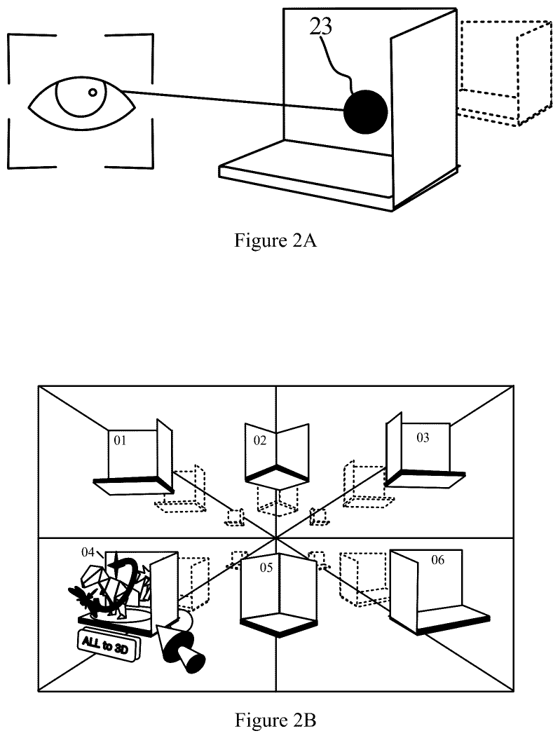

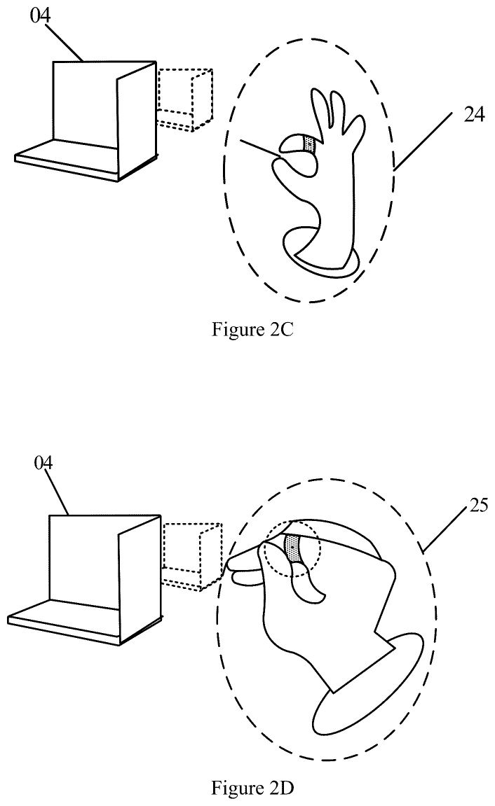

FIG. 2A illustrates a schematic diagram for determining a target application by eye movement, consistent with the disclosed embodiments of the present disclosure. FIG. 2A includes a gaze point 23. FIG. 2B illustrates a schematic interface diagram for determining a target application, consistent with the disclosed embodiments of the present disclosure. FIG. 2B includes a target application 04. During an implementation process, the application 04 shown in FIG. 2B, corresponding to the gaze point 23 shown in FIG. 2A, may be determined as the target application.

S160: when it is determined that the gesture of the user matches a first preset gesture, determining the target application based on distance information between the accessory device and each application displayed on the interface in the three-dimensional display mode.

During an implementation process, the user may set a first preset gesture. FIG. 2C illustrates a schematic diagram of a pinch gesture consistent with the disclosed embodiments of the present disclosure. FIG. 2C includes a pinch gesture 24 and a target application 04. During the implementation process, the user may set the pinch gesture 24 shown in FIG. 2C as the first preset gesture. The distance information between the accessory device and each application displayed on the interface in the 3D display mode may be determined based on a distance sensor or a camera device of the autostereoscopic device. In this way, when it is determined that the gesture of the user matches the first preset gesture, the application closest to the accessory device may be determined as the target application.

For example, when it is determined that the user performs the pinch gesture 24 as shown in FIG. 2C, the application 04 closest to the accessory device or the user's finger as shown in FIG. 2B may be determined as the target application.

S170: in response to the target instruction sent by the accessory device, determining the target application based on the distance information between the accessory device and each application displayed on the interface in the three-dimensional display mode. The target instruction may be generated by a user touching a preset touch area of the accessory device.

The user may generate a target instruction through a preset touch area of the touch accessory device. FIG. 2D illustrates a schematic operation diagram for generating a target instruction, consistent with the disclosed embodiments of the present disclosure. FIG. 2D includes a double-click gesture 25 and a target application 04. During the implementation process, a user may generate a target instruction by double-clicking the preset touch area, and determine the application 04 closest to the accessory device as the target application.

In one embodiment, the target application may be determined based on the gaze point of the user. Alternatively, the target application may be determined based on the gesture of the user and the distance information between the accessory device and each application displayed on the interface in the three-dimensional display mode. Alternatively, the target application may be determined in response to a target instruction sent by an accessory device, and based on distance information between the accessory device and each application displayed on the interface in the three-dimensional display mode. That is, the user may choose to execute one of the above approaches and determine the target application to be operated in the three-dimensional display interface.

In some embodiments, the interaction method also includes at least one of S180 and/or S190.

S180: using a camera device of the autostereoscopic device to obtain the gaze point of the user or the gesture of the user.

During an implementation process, a camera device of the autostereoscopic device for example, a camera disposed on an autostereoscopic display screen, may be used to determine the gaze point of the user or collect the gesture of the user image, for determining the application that matches the gaze point of the user, or determining whether the gesture of the user matches the preset gesture.

S190: acquiring sensor data information of the accessory device to determine a gesture of the user based on the sensor data information. The muscle activity data information may be obtained by using the muscle activity sensors disposed in the accessory device. The IMU sensor, displacement sensor and angle displacement sensor may obtain motion data information, the pressure sensor may obtain data information on whether the finger is bent, and the camera may obtain gesture information.

During an implementation process, the gesture of the user may be determined based on at least one of the following sensor information: muscle activity data information, finger movement data information, data information on whether the finger is bent, and gesture information.

In one embodiment, the camera device of the autostereoscopic device may be used to determine the gaze point of the user or the gesture of the user. Alternatively, the sensor data information of the accessory device may be used to determine the gesture of the user.

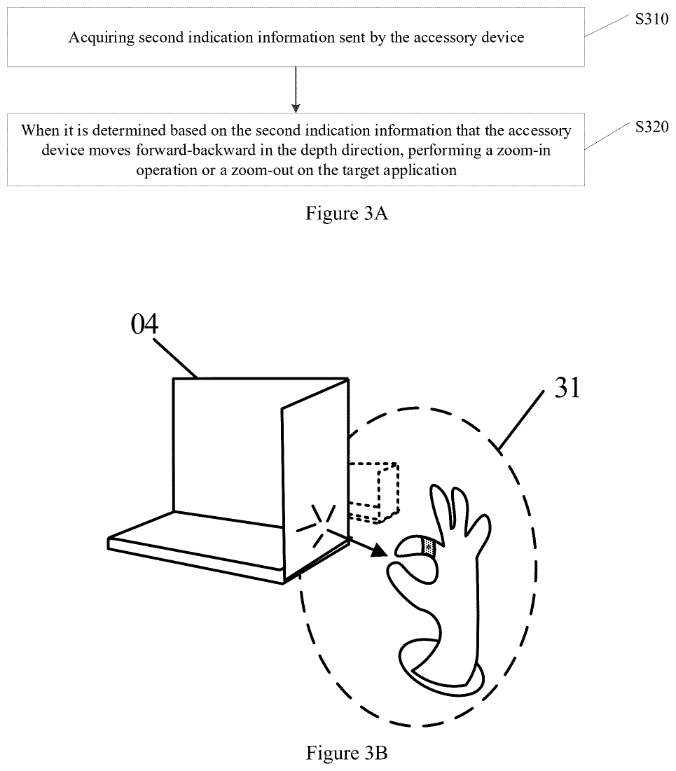

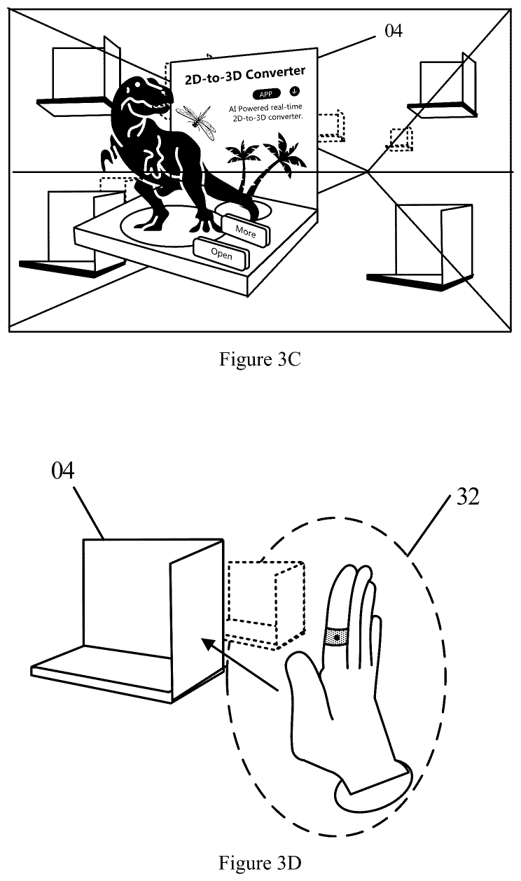

FIG. 3A illustrates an implementation flow chart of another interaction method consistent with the disclosed embodiments of the present disclosure. As shown in FIG. 3A, in some embodiments, the interaction method may also include S310 and S320.

S310: acquiring second indication information sent by the accessory device. Acquiring the second indication information may be performed after determining the target application. That is, the second indication information may be information for operating the target application.

S320: when it is determined based on the second indication information that the accessory device moves forward-backward in the depth direction, performing a zoom-in operation or a zoom-out on the target application.

FIG. 3B illustrates a schematic diagram of a gesture for bringing a target application closer, consistent with the disclosed embodiments of the present disclosure. FIG. 3B includes a zoom-in gesture 31 and a target application 04 being zoomed in. FIG. 3C illustrates a schematic diagram for displaying a target application on an autostereoscopic device consistent with the disclosed embodiments of the present disclosure. FIG. 3C includes the target application 04. During an implementation process, the user may hold the accessory device and move the accessory device backward in the depth direction (Z axis) to perform the zoom-in gesture 31 as shown in FIG. 3B, such that the target application 04 may be brought closer and presented on the display interface as shown in FIG. 3C.

FIG. 3D illustrates a schematic diagram of a gesture for restoring a target application consistent with the disclosed embodiments of the present disclosure. FIG. 3D includes a push back gesture 32 and a target application 04 that is pushed back. During an implementation process, the user may hold the accessory device and move the accessory device forward in the depth direction to perform the push back gesture 32 as shown in FIG. 3D. As such, the target application 04 may be restored and presented on the display interface as shown in FIG. 2B.

In one embodiment, the second indication information sent by the accessory device may be obtained first. Then, when it is determined based on the second indication information that the accessory device moves forward-backward in the depth direction, a zoom-in operation or a zoom-out may be performed on the target application. In this way, after the target application is determined, a zoom-in operation or a zoom-out may be performed on the target application based on the forward-backward movement of the accessory device in the depth direction.

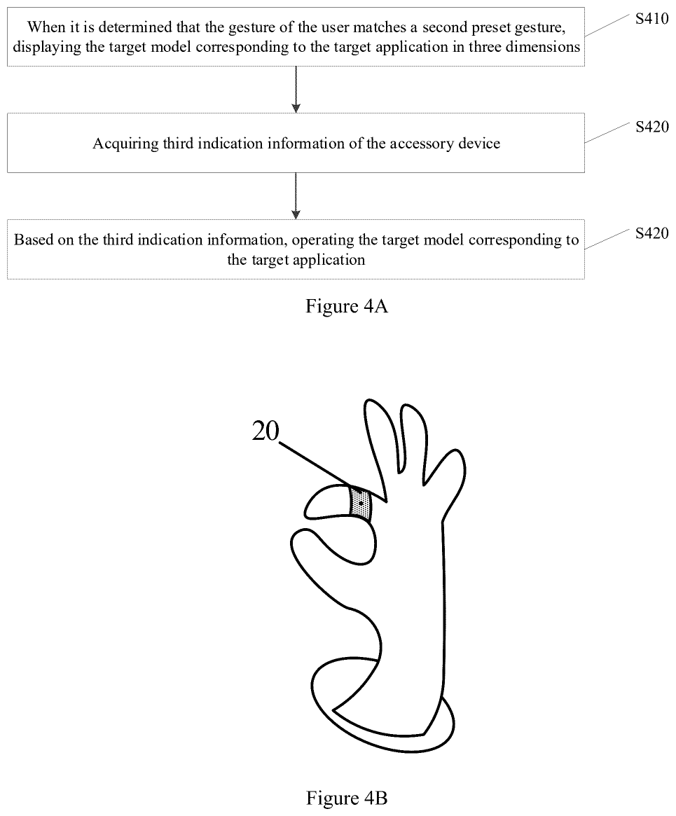

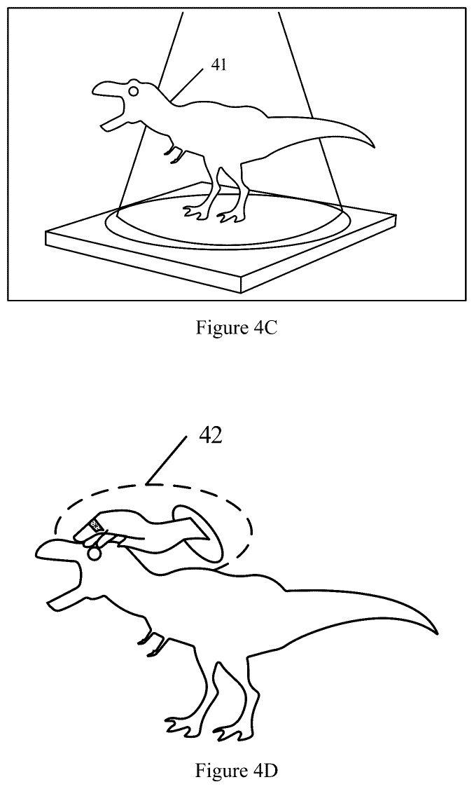

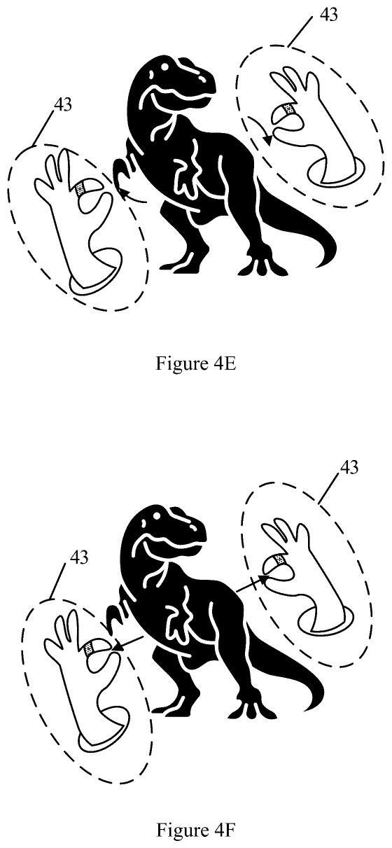

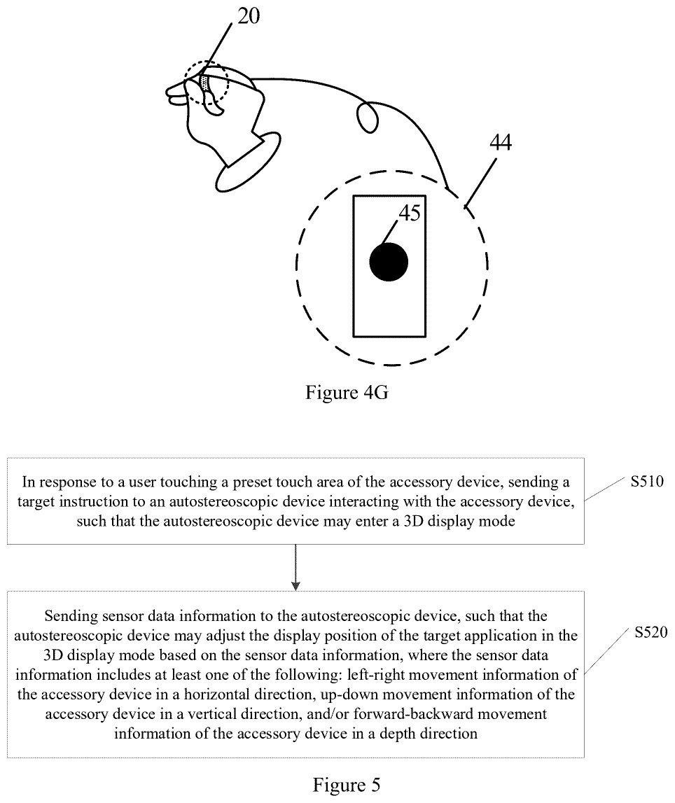

FIG. 4A illustrates an implementation flow chart for operating a target model, consistent with the disclosed embodiments of the present disclosure. In some embodiments, as shown in FIG. 4A, operating the target model corresponding to the target application may be implemented by S410, S420, and S430.

S410: when it is determined that the gesture of the user matches a second preset gesture, displaying the target model corresponding to the target application in three dimensions. The user may set the second preset gesture according to his/her usage habits. For example, the user may set a fist, open palm, bend fingers, or pinch with two fingers together as the preset gesture.

FIG. 4B illustrates a schematic diagram of a second preset gesture consistent with the disclosed embodiments of the present disclosure. FIG. 4B includes a smart ring 20. FIG. 4C illustrates a schematic diagram of a three-dimensional display of a dinosaur model, consistent with the disclosed embodiments of the present disclosure. FIG. 4C includes a dinosaur model 41. During an implementation process, when the gesture of the user is determined to be a pinching gesture of two fingers touching each other as shown in FIG. 4B based on the sensor data of the smart ring 20, the target model (dinosaur model) shown in FIG. 3C corresponding to the target application closest to the accessory device or the user's finger may be displayed in three dimensions as the dinosaur model 41 as shown in FIG. 4C.

S420: acquiring third indication information of the accessory device. The third indication information is indication information used to operate the target model. The third indication information may be obtained after the target model presents a three-dimensional display. The third indication information may be used to characterize the displacement of the accessory device and various gesture information of the user.

S430: based on the third indication information, operating the target model corresponding to the target application.

In one embodiment, when it is determined that the gesture of the user matches the second preset gesture, the target model corresponding to the target application may be displayed in three dimensions first. The third indication information of the accessory device may then be obtained. Finally, the target model corresponding to the target application may be operated based on the third indication information. In this way, the target model selected by the user may be displayed in three dimensions, and the target model may be operated by the user operating the accessory device.

In some embodiments, an operation of S430 “based on the third indication information, operating the target model corresponding to the target application” may be implemented by at least one of S431, S432 and S433.

S431: determining that the gesture of the user matches the third preset gesture, and when it is determined, based on the third indication information, that the accessory device makes an up-down movement in the vertical direction, performing touch interaction on the target model.

FIG. 4D illustrates a schematic diagram of an interaction with a target model consistent with the disclosed embodiments of the present disclosure. For example, as shown in FIG. 4D, the user may make a gesture 42 of patting the dinosaur model. Simultaneously, it may be determined, based on the third indication information, that when the user pats lightly, the dinosaur runs slowly, and when the user taps hard, the dinosaur runs fast. The severity of the tap by the user may be determined based on the acceleration of the accessory device (smart ring) moving up-down in the vertical direction.

S432: determining that the gesture of the user matches a fourth preset gesture, and when it is determined, based on the third indication information, that the movement information of the accessory device matches the preset rotation movement information, performing a rotation operation on the target model.

FIG. 4E illustrates a schematic diagram of another interaction with a target model consistent with the disclosed embodiments of the present disclosure. For example, as shown in FIG. 4E, the user may make a gesture 43 of pinching the dinosaur model. Simultaneously, when it is determined, based on the third indication information, that the accessory device is rotating, a rotation operation may be synchronously performed on the dinosaur model. A user may wear a smart ring on one hand, or simultaneously wear a smart ring on each hand. Alternatively, the user may not wear a smart ring, and a camera device of the three-dimensional naked-eye device may recognize the gesture of the user.

S433: determining that the gesture of the user matches a fifth preset gesture, and when it is determined, based on the third indication information, that the accessory device moves left-right in the horizontal direction, performing a zoom-in or zoom-out operation on the target model accordingly.

FIG. 4F illustrates a schematic diagram of another interaction with a target model consistent with the disclosed embodiments of the present disclosure. For example, as shown in FIG. 4F, a user may make a pinching gesture 43 to hold the dinosaur model. Simultaneously, when it is determined, based on the third indication information, that the accessory device moves left-right in the horizontal direction, a zoom-in or zoom-out operation may be performed on the dinosaur model. A user may wear a smart ring on one hand, or simultaneously wear a smart ring on each hand. Alternatively, the user may not wear a smart ring, and a camera device of the three-dimensional naked-eye device may recognize the gesture of the user.

In one embodiment, when it is determined that the gesture of the user matches the third preset gesture, and it is determined, based on the third indication information, that the up-down movement of the accessory device in the vertical direction matches, touch interaction may be performed on the target model. When it is determined that the gesture of the user matches the fourth preset gesture and, and based on the third indication information, it is determined that the movement information of the accessory device matches the preset rotation movement information, a rotation operation may be performed on the target model. When it is determined that the gesture of the user matches the fifth preset gesture, and it is determined, based on the third indication information, that the accessory device moves left-right in the horizontal direction, a zoom-in or zoom-out operation may be performed on the target model.

In some embodiments, exiting the three-dimensional display of the target model may be achieved by S440: in response to a target instruction sent by the accessory device, exiting the three-dimensional display of the target model.

The target instruction may be triggered by the user touching a preset touch area of the accessory device. FIG. 4G illustrates a schematic diagram of a user touching a return key, consistent with the disclosed embodiments of the present disclosure. FIG. 4G includes a smart ring 20 and a home button 45 shown in a ring zoom movement sub-diagram 44. During the implementation process, the user may click the home button 45 set on the smart ring 20 to trigger the exit of the three-dimensional display of the target model, that is, to return to the interface display shown in FIG. 1B. During the implementation process, a red button may be set on the smart ring such that the user may click the red button to trigger an operation corresponding to the home button.

In one embodiment, in response to the target instruction sent by the accessory device, exiting the three-dimensional display of the target model, that is, returning to the three-dimensional display of the main page, may be realized.

In some embodiments, adjusting the interface display in the three-dimensional mode may be achieved by S210 and S220.

S210: acquiring fourth indication information sent by the accessory device. The fourth indication information includes at least one of the following information pieces: horizontal left-right movement information, vertical up-down movement information, and/or depth direction forward-backward movement information.

S220: based on the fourth indication information, adjusting the interface display in the three-dimensional display mode. Adjusting the 3D interface display may include changing an overall viewing angle of the interface, changing overall brightness of the interface, and moving the interface up, down, left, and right overall.

For example, when it is determined that the accessory device moves left-right, the overall viewing angle of the interface may also change left-right. When it is determined that the accessory device moves up-down, the interface may correspondingly move up-down overall. When it is determined that the accessory device moves forward-backward, the overall brightness and darkness of the interface may be adjusted.

In one embodiment, the interaction method includes acquiring the fourth indication information sent by the accessory device, and adjusting the interface display in the three-dimensional display mode may be adjusted based on the fourth indication information. In this way, the interaction between the accessory device and the autostereoscopic device may be utilized to adjust the interface display in the three-dimensional display mode.

In some embodiments, before S110 “acquiring first indication information sent by an accessory device interacting with the autostereoscopic device”, the interaction method also includes: in response to a target instruction sent by the accessory device, entering the three-dimensional display mode. The target instruction may be generated by a user touching a preset touch area of the accessory device.

The target instruction may be triggered by a user touching a preset touch area of the accessory device. For example, as shown in FIG. 4G, the user may click the home button set on the accessory device to trigger the autostereoscopic device entering the three-dimensional display mode, that is, entering the interface display shown in FIG. 1B.

In one embodiment, in response to the target instruction sent by the accessory device, the autostereoscopic device may switch from a two-dimensional display mode to a three-dimensional display mode.

The present disclosure provides another interaction method. The interaction method is applicable to an accessory device. FIG. 5 illustrates an implementation flow chart of another interaction method consistent with the disclosed embodiments of the present disclosure. As shown in FIG. 5, in one embodiment, the interaction method includes S510 and S520.

S510: in response to a user touching a preset touch area of the accessory device, sending a target instruction to an autostereoscopic device interacting with the accessory device, such that the autostereoscopic device may enter a 3D display mode.

S520: sending sensor data information to the autostereoscopic device, such that the autostereoscopic device may adjust the display position of the target application in the 3D display mode based on the sensor data information. The sensor data information includes at least one of the following: left-right movement information of the accessory device in a horizontal direction, up-down movement information of the accessory device in a vertical direction, and/or forward-backward movement information of the accessory device in a depth direction.

In one embodiment, in response to a user touching a preset touch area of the accessory device, a target instruction may be sent to an autostereoscopic device interacting with the accessory device. Sensor data information may be sent to the autostereoscopic device, such that the autostereoscopic device may adjust a display position of a target application in the 3D display mode based on the sensor data information. In this way, the user may operate the accessory device to control the autostereoscopic device to enter a 3D display mode, and through interaction with the autostereoscopic device, adjust the display position of the target application in the 3D mode accordingly.

The present disclosure also provides two interactive devices. The interactive devices include modules, and each module includes a sub-module. The interactive devices may be implemented by a processor in an electronic device, and may also be realized through a specific logic circuit. During an implementation process, the processor may be a central processing unit (CPU), a microprocessor unit (MPU), a digital signal processor (DSP), or a field programmable gate array (FPGA).

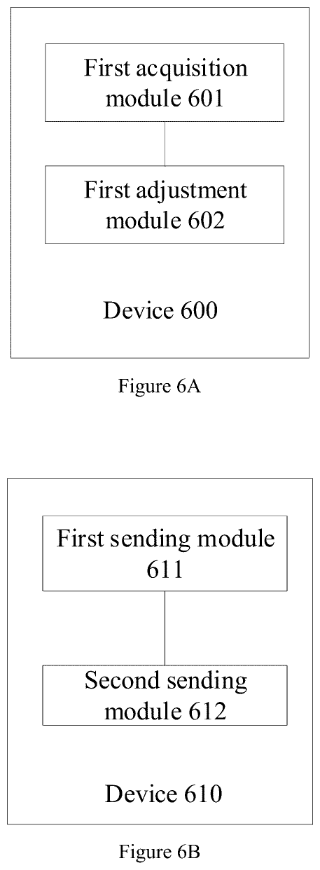

FIG. 6A illustrates a schematic diagram of a composition structure of an interactive device consistent with the disclosed embodiments of the present disclosure. In one embodiment, as shown in FIG. 6A, the device 600 includes a first acquisition module 601 and a first adjustment module 602.

The first acquisition module 601 is configured to acquire first indication information sent by an accessory device interacting with the autostereoscopic device. The first indication information includes at least one of the following information pieces: horizontal left-right movement information, vertical up-down movement information, and/or depth-wise forward-backward movement information.

The first adjustment module 602 is configured to adjust a display position of a target application in a 3D display mode of the autostereoscopic device based on the first indication information.

In some embodiments, the first adjustment module 602 includes a first determination submodule and a first adjustment submodule. The first determination submodule is configured to determine, based on the first indication information, that the accessory device moves in at least one of the following movements: vertical up-down movement, horizontal left-right movement, or depth-wise forward-backward movement. The first adjustment submodule is configured to perform at least one of the following adjustments in the three-dimensional display mode: adjusting the vertical position of at least one of the target applications, adjusting the display viewing angle of at least one of the target applications, and/or adjusting the front and back position of at least one of the target applications in the depth direction.

In some embodiments, the interaction device may also include a first determination module and a second adjustment module. The first determination module is configured to determine whether the accessory device is triggered to rotate or the user touches and slides on the surface of the accessory device. The second adjustment module is configured to perform at least one of the following adjustments in the three-dimensional display mode: adjusting the vertical position of at least one of the target applications, adjusting the display viewing angle of at least one of the target applications, and/or adjusting the front and back positions of at least one of the target applications in the depth direction.

In some embodiments, the interaction device also includes at least one of the following modules: a second determination module, a third determination module, and/or a fourth determination module. The second determination module is configured to determine the application matching the gaze point of the user as the target application. The third determination module is configured to, when it is determined that the gesture of the user matches the first preset gesture, determine the target application based on the distance information between the accessory device and each application displayed on the interface in the three-dimensional display mode. The fourth determination module is configured to, in response to the target instruction sent by the accessory device, determine the target application based on the distance information between the accessory device and each application displayed on the interface in the three-dimensional display mode. The target instruction may be generated by the user touching a preset touch area of the accessory device.

In some embodiments, the interaction device may also include a second acquisition module and/or a third acquisition module. The second acquisition module is configured to acquire the gaze point of the user or the gesture of the user by using the camera device of the autostereoscopic device. The third acquisition module is configured to acquire sensor data information of the accessory device, such that the gesture of the user may be determined based on the sensor data information.

In some embodiments, the interaction device may also include a fourth acquisition module and a first operation module. The fourth acquisition module is configured to acquire the second indication information sent by the accessory device. The first operation module is configured to execute a zoom-in operation or a zoom-out on the target application when it is determined, based on the second indication information, that the accessory device moves forward-backward in the depth direction.

In some embodiments, the interactive device may also include a display module, a fifth acquisition module and a second operation module. The display module is configured to display the target model corresponding to the target application in three dimensions when it is determined that the gesture of the user matches the second preset gesture. The fifth acquisition module is configured to acquire third indication information of the accessory device. The second operation module is configured to operate the target model corresponding to the target application based on the third indication information.

In some embodiments, the second operation module includes at least one of the following submodules: a touch interaction submodule, a rotation operation submodule, and a zoom operation submodule. The touch interaction submodule is configured to determine that the gesture of the user matches a third preset gesture, and when it is determined based on the third indication information that the vertical movement of the accessory device matches the third preset gesture, perform touch interaction on the target model. The rotation operation submodule is configured to determine whether the gesture of the user matches a fourth preset gesture, and when it is determined based on the third indication information that the movement information of the accessory device matches the preset rotation movement information, perform a rotation operation on the target model. The zoom operation submodule is configured to determine whether the gesture of the user matches the fifth preset gesture, and when it is determined, based on the third indication information, that the accessory device moves left-right in the horizontal direction, correspondingly perform a zoom-in or zoom-out operation on the target model.

In some embodiments, the interaction device may also include an exit module for exiting the three-dimensional display of the target model in response to the target instruction sent by the accessory device.

In some embodiments, the interaction device also includes a sixth acquisition module and a third adjustment module. The sixth acquisition module is configured to acquire fourth indication information sent by the accessory device. The third adjustment module is configured to adjust the interface display in the three-dimensional display mode based on the fourth indication information.

In some embodiments, the interaction device may also include an entry module for entering the three-dimensional display mode in response to the target instruction sent by the accessory device. The target instruction may be generated by a user touching a preset touch area of the accessory device.

FIG. 6B illustrates a schematic diagram of a composition structure of another interactive device consistent with the disclosed embodiments of the present disclosure. In one embodiment, as shown in FIG. 6B, the interactive device 610 includes a first sending module 611 and a second sending module 612.

The first sending module 611 is configured to, in response to a user touching a preset touch area of the accessory device, send a target instruction to an autostereoscopic device interacting with the accessory device, such that the autostereoscopic device enters a 3D display mode.

The second sending module 612 is configured to send sensor data information to the autostereoscopic device, such that the autostereoscopic device may adjust the display position of the target application in the 3D display mode based on the sensor data information. The sensor data information includes at least one of the following: left-right movement information of the accessory device in a horizontal direction, up-down movement information of the accessory device in a vertical direction, and/or forward-and-backward movement information of the accessory device in a depth direction.

The interaction device provided by the present disclosure may have similar beneficial effects as the interaction method provided by the present disclosure. For technical details of the interaction device, reference may be made to the descriptions of the interaction method in the present disclosure.

It should be noted that, in one embodiment, the interaction method may be implemented in the form of a software function module and sold or used as an independent product, and the interaction method may also be stored in a computer-readable storage medium. Based on this understanding, the technical solution, or in other words, the part that contributes to the relevant technology, of the present disclosure may be embodied in the form of a software product. The software product may be stored in a storage medium, and may include a plurality of instructions for enabling an electronic device (which may be a mobile phone, tablet computer, laptop computer, desktop computer, etc.) to execute the whole of or part of the method provided by the present disclosure. The storage medium may include U disk, mobile hard disk, read only memory (ROM), magnetic disk, CD, and other media that may store program codes. The present disclosure does not limit a specific combination of hardware and software.

The present disclosure also provides a storage medium on which a computer program is stored. When the computer program is executed by a processor, operations in the interaction method provided by the present disclosure may be performed.

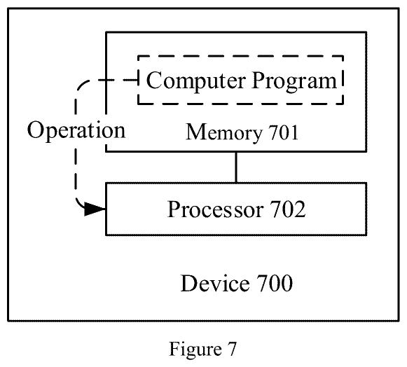

The present disclosure also provides an electronic device. FIG. 7 illustrates a schematic diagram of a hardware entity of an electronic device consistent with the disclosed embodiments of the present disclosure. In one embodiment, as shown in FIG. 7, the hardware entity of the device 700 includes a memory 701 and a processor 702. A computer program that may run on the processor 702 is stored in the memory 701. When the processor 702 executes the computer program, the interaction method provided by the present disclosure may be implemented.

The memory 701 is configured to store instructions and applications executable by the processor 702, and may also cache data to be processed or processed by the processor 702 and various modules in the electronic device 700 (for example, image data, audio data, voice communication data, and video communication data). The memory may be implemented through flash memory (FLASH) or random access memory (RAM).

It should be pointed out that the storage medium and the electronic device provided by the present disclosure may have similar beneficial effects as the interaction method provided by the present disclosure. For technical details of the storage medium and device provided by the present disclosure, reference may be made to the descriptions of the interaction method in the present disclosure.

It should be noted that, the devices and methods provided by the present disclosure may be implemented in other approaches. The embodiments in the present disclosure are merely illustrative. For example, unit division is merely logical function division. There may be other division methods in actual implementation. For example, a part of units or components may be combined, or may be integrated into another system, and a part of features may be ignored, or not performed. In addition, couplings between components may be direct couplings, or may be achieved through indirect couplings or communication connections through interfaces, devices, or units. The couplings may be electrical, mechanical or other forms.

The units described as separate components may or may not be physically separate. Components shown as units may or may not be physical units. The components may disposed in one place or distributed over a plurality of network units. Part of or each of the units may be selected according to actual needs to achieve the technical solutions of the present disclosure.

In addition, functional units in the embodiments of the present disclosure may be integrated into one processing unit, or each unit may be separately used as a unit, or two or more units may be integrated into a unit. The unit formed by integration may be implemented in the form of hardware, or in the form of hardware combined with software functional units.

Each or part of the operations of the method embodiments may be completed by hardware related to instructions of a program. The program may be stored in a computer-readable storage medium. When the program is executed, the operations of the method embodiments may be performed. The storage medium may include mobile storage devices, read-only memories (ROM), magnetic disks or optical disks, and other media that may store program codes.

When the unit formed by integration is implemented in the form of a software function module and sold or used as an independent product, the unit formed by integration may also be stored in a computer-readable storage medium. Based on this understanding, the technical solution of the present disclosure, or in other words, the part that contributes to the relevant technology, may be embodied in the form of a software product. The software product may be stored in a storage medium, and may include a plurality of instructions for enabling an electronic device (which may be a mobile phone, tablet computer, laptop computer, desktop computer, etc.) to execute each or part of the methods described in the present disclosure. The storage medium may include mobile storage devices, ROM, magnetic disks, optical disks, and other media that may store program codes.

As disclosed, the technical solutions of the present disclosure have the following advantages.

In the present disclosure, based on the first indication information, the accessory device may be determined to move in at least one of the following directions: up-down in the vertical direction, left-right in the horizontal direction, or forward-backward in the depth direction. At least one of the following adjustments in the three-dimensional display mode may be performed: adjusting the vertical position of at least one of the target applications, adjusting the display viewing angle of at least one of the target applications, or adjusting the front-back position of at least one of the target applications in the depth direction. In this way, the user may set the moving direction of the accessory device and the moving direction of the corresponding target application according to his/her own usage habits. Accordingly, the movement of the accessory device may correspond to the position adjustment of the corresponding target application.

The embodiments disclosed in the present disclosure are exemplary only and not limiting the scope of the present disclosure. Various combinations, alternations, modifications, or equivalents to the technical solutions of the disclosed embodiments may be obvious to those skilled in the art and may be included in the present disclosure. Without departing from the spirit of the present disclosure, the technical solutions of the present disclosure may be implemented by other embodiments, and such other embodiments are intended to be encompassed within the scope of the present disclosure.

What is claimed is:

1. An interaction method, applied to an autostereoscopic device, comprising:
acquiring first indication information sent by an accessory device interacting with the autostereoscopic device, wherein the first indication information includes at least one of following information: left-right movement information in a horizontal direction, up-down movement information in a vertical direction, or forward-backward movement information in a depth direction; and
based on the first indication information, adjusting a display position of a target application in a three-dimensional display mode of the autostereoscopic device.

2. The method according to claim 1, wherein adjusting the display position of the target application in the three-dimensional display mode of the autostereoscopic device includes:
based on the first indication information, determining that the accessory device makes at least one of following movements: an up-down movement in the vertical direction, a left-right movement in the horizontal direction, or a forward-backward movement in the depth direction; and
performing at least one of following adjustments in the three-dimensional display mode: adjusting a vertical up-down position of at least one target application of the target application, adjusting a display viewing angle of at least one target application of the target application, or adjusting a depth-wise front-back position of at least one target application of the target application.

3. The method according to claim 1, further comprising:
determining that the accessory device is triggered to rotate, or a user touches and slides on a surface of the accessory device; and
performing at least one of following adjustments in the three-dimensional display mode: adjusting a vertical up-down position of at least one target application of the target application, adjusting a display viewing angle of at least one target application of the target application, or adjusting a depth-wise front-back position of at least one target application of the target application.

4. The method according to claim 1, further comprising:
determining an application matching a gaze point of a user as the target application; or
when it is determined that a gesture of the user matches a first preset gesture, determining the target application based on distance information between the accessory device and each application displayed on an interface in the three-dimensional display mode; or
in response to a target instruction sent by the accessory device, determining the target application based on the distance information between the accessory device and each application displayed on the interface in the three-dimensional display mode, wherein the target instruction is generated by the user touching a preset touch area of the accessory device.

5. The method according to claim 4, further comprising:
using a camera device of the autostereoscopic device to obtain the gaze point of the user or the gesture of the user; and/or
acquiring sensor data information of the accessory device to determine the gesture of the user based on the sensor data information.

6. The method according to claim 4, further comprising:
acquiring second indication information sent by the accessory device; and
when it is determined based on the second indication information that the accessory device makes a forward-backward movement in the depth direction, performing a zoom-in operation or a zoom-out operation on the target application.

7. The method according to claim 4, further comprising:
when it is determined that the gesture of the user matches a second preset gesture, displaying a target model corresponding to the target application in three dimensions;
acquiring third indication information of the accessory device; and
based on the third indication information, operating the target model corresponding to the target application.

8. The method according to claim 7, wherein operating the target model corresponding to the target application includes:
determining that the gesture of the user matches a third preset gesture, and when it is determined, based on the third indication information, that the accessory device makes an up-down movement in the vertical direction, performing touch interaction on the target model;
determining that the gesture of the user matches a fourth preset gesture, and when it is determined, based on the third indication information, that movement information of the accessory device matches a preset rotation movement information, performing a rotation operation on the target model; and
determining that the gesture of the user matches a fifth preset gesture, and when it is determined, based on the third indication information, that the accessory device makes a left-right movement in the horizontal direction, performing a zoom-in or zoom-out operation on the target model accordingly.

9. The method according to claim 7, further comprising:
in response to the target instruction sent by the accessory device, exiting a three-dimensional display of the target model.

10. The method according to claim 8, further comprising:
acquiring fourth indication information sent by the accessory device; and
based on the fourth indication information, adjusting an interface display in the three-dimensional display mode.

11. The method according to claim 1, before acquiring the first indication information sent by
the accessory device interacting with the autostereoscopic device, further comprising:
in response to a target instruction sent by the accessory device, entering the three-dimensional display mode, wherein the target instruction is generated by a user touching a preset touch area of the accessory device.

12. An autostereoscopic device, comprising a memory, one or more processors, and an autostereoscopic display screen, wherein:
the autostereoscopic display screen is configured to display a target application in a three-dimensional display mode; and
the memory is configured to store a computer program that, when being executed, causes the one or more processors to perform:
acquiring first indication information sent by an accessory device interacting with the autostereoscopic device, wherein the first indication information includes at least one of following information: left-right movement information in a horizontal direction, up-down movement information in a vertical direction, or forward-backward movement information in a depth direction; and
based on the first indication information, adjusting a display position of the target application in the three-dimensional display mode of the autostereoscopic device.

13. The device according to claim 12, wherein the one or more processors are further configured to perform:
based on the first indication information, determining that the accessory device makes at least one of following movements: an up-down movement in the vertical direction, a left-right movement in the horizontal direction, or a forward-backward movement in the depth direction; and
performing at least one of following adjustments in the three-dimensional display mode: adjusting a vertical up-down position of at least one target application of the target application, adjusting a display viewing angle of at least one target application of the target application, or adjusting a depth-wise front-back position of at least one target application of the target application.

14. The device according to claim 12, wherein the one or more processors are further configured to perform:
determining that the accessory device is triggered to rotate, or a user touches and slides on a surface of the accessory device; and
performing at least one of following adjustments in the three-dimensional display mode: adjusting a vertical up-down position of at least one target application of the target application, adjusting a display viewing angle of at least one target application of the target application, or adjusting a depth-wise front-back position of at least one target application of the target application.

15. The device according to claim 12, wherein the one or more processors are further configured to perform:
determining an application matching a gaze point of a user as the target application; or
when it is determined that a gesture of the user matches a first preset gesture, determining the target application based on distance information between the accessory device and each application displayed on an interface in the three-dimensional display mode; or
in response to a target instruction sent by the accessory device, determining the target application based on the distance information between the accessory device and each application displayed on the interface in the three-dimensional display mode, wherein the target instruction is generated by the user touching a preset touch area of the accessory device.

16. The device according to claim 15, wherein the one or more processors are further configured to perform:
using a camera device of the autostereoscopic device to obtain the gaze point of the user or the gesture of the user; and/or
acquiring sensor data information of the accessory device to determine the gesture of the user based on the sensor data information.

17. The device according to claim 15, wherein the one or more processors are further configured to perform:
acquiring second indication information sent by the accessory device; and
when it is determined based on the second indication information that the accessory device makes a forward-backward movement in the depth direction, performing a zoom-in operation or a zoom-out operation on the target application.

18. The device according to claim 15, wherein the one or more processors are further configured to perform:
when it is determined that the gesture of the user matches a second preset gesture, displaying a target model corresponding to the target application in three dimensions;
acquiring third indication information of the accessory device; and
based on the third indication information, operating the target model corresponding to the target application.

19. The device according to claim 18, wherein the one or more processors are further configured to perform:
determining that the gesture of the user matches a third preset gesture, and when it is determined, based on the third indication information, that the accessory device makes an up-down movement in the vertical direction, performing touch interaction on the target model;
determining that the gesture of the user matches a fourth preset gesture, and when it is determined, based on the third indication information, that movement information of the accessory device matches a preset rotation movement information, performing a rotation operation on the target model; and
determining that the gesture of the user matches a fifth preset gesture, and when it is determined, based on the third indication information, that the accessory device makes a left-right movement in the horizontal direction, performing a zoom-in or zoom-out operation on the target model accordingly.

20. A non-transitory computer readable storage medium containing a computer program that, when being executed, causes at least one processor to perform:
acquiring first indication information sent by an accessory device interacting with an autostereoscopic device, wherein the first indication information includes at least one of following information: left-right movement information in a horizontal direction, up-down movement information in a vertical direction, or forward-backward movement information in a depth direction; and
based on the first indication information, adjusting a display position of the target application in the three-dimensional display mode of the autostereoscopic device.
